(19) United States
(12) Patent Application Publication
(10) Pub. No.: US 2024/0183733 A1
(43) Pub. Date: Jun. 6, 2024

(54) Separating Pressure Transducer for Measuring Pressure in a Polluted Environment

(71) Applicant: PITTWAY SARL, Rolle (CH)

(72) Inventors: Pavel Kejik, Rolle (CH); Petr Koblizek, Rolle (CH); Martin Klima, Rolle (CH); Jaroslav Volavy, Rolle (CH); Fabio Mariani, Rolle (CH); Alita Nichols, Rolle (CH); Mohammad A. Aljabari, Rolle (CH)

(21) Appl. No.: 18/553,060

(22) PCT Filed: Mar. 28, 2022
(86) PCT No.: PCT/EP2022/058155

§ 371 Date: Sep. 28, 2023

(30) Foreign Application Priority Data
Mar. 31, 2021 (EP) 21166244.0

(51) Int. Cl. G01L 19/00; B33Y 80/00; G01L 19/06

(52) U.S. Cl. CPC G01L 19/0007; B33Y 80/00; G01L 19/0627

(57) ABSTRACT

There is provided a pressure sensing device comprising a first elongated hollow member comprising a first opening located at a first end of the first elongated hollow member: a second opening located at a second end opposite to the first end of the elongated hollow member: a third opening located at between the first and the second end of the first elongated hollow member. The pressure sensing device further comprises a second elongated hollow member, the second elongated hollow member being connected to the first elongated hollow member via the third opening, wherein the first opening being configured to connect the inside of the second elongated member to the inside of a third hollow member: one of the free end of the second elongated member or third opening configured to open out to external atmospheric pressure through an aperture: and a pressure sensing element being connected to the other one of the free end of the second elongated member or the third opening. There is also provided a method for measuring pressure using the pressure sensing device.

### TECHNICAL FIELD

This invention relates to pressure sensing in polluted environments. In particular, the invention relates to a device and method for measuring pressure inside a hollow member, such as a chimney, flue or the like, while separating the pressure transducer from the pollutions present in the polluted environment within the chimney, flue or the like.

### BACKGROUND

It is widely known that pressurised systems require the pressure to be measured and monitored for a variety of reasons. For example, a closed pressure system having pressures above or below atmospheric pressure may need to be monitored for safety or efficiency reasons. Other systems and reasons will be apparent to the appropriate person skilled in the art based on the application of the pressurised system. Nevertheless, some of these pressurised systems may be subject to an aggressive environment, such that the chemicals and/or particles within the environment have an impact on the pressure sensing device. These environments can have detrimental effects on the operations and the longevity of the sensing element within the pressure sensing device. As such, a reduction in measuring efficiency and operating lifetime of the sensor is common in some pressurised systems, leading to an increase in the frequency of repairs or replacement of the pressure sensing device. Alternatively or in addition thereto, the prior art teaches the use of encapsulated or otherwise protected pressure sensing devices for increasing the resistance against said chemicals and/or particles in the environment in which the pressure is to be sensed. Therefore, there is a need to improve the operating efficiency of pressure sensing devices over the device lifetime while increasing the operational lifetime of the device.

### SUMMARY OF INVENTION

It is an object of the invention to provide a pressure sensing devices and methods for sensing pressure for use in polluted environments with increased operational lifetime while maintaining high pressure measuring efficiency of the associated pressurised system according to the appended claims. The invention is further directed to computer-readable media having computer-executable instructions adapted to cause a 3D printer to print the pressure sensing devices according to the invention.

### BRIEF DESCRIPTION OF THE DRAWINGS

FIG. 1 shows a diagram of the pressure sensor device with the elongated hollow member, an opening to the atmosphere, an opening connectable to a chimney or flue, and the pressure sensing element shown.

FIGS. 2a-c represent 2D and 3D graphical pressure simulation results measured at the pressure sensing element wherein the diameter and length of the pipe have been modified over a selected range, Dₚᵢₚₑ is 3-9 mm and Lₚᵢₚₑ is 300-900 mm, while keeping other variables constant.

FIG. 3 is a 3D graph of simulation results wherein the length of the pipe, Lₚᵢₚₑ is changed from 0 mm to 5000 mm and the diameter, Dₚᵢₚₑ is changed from 3 mm to 9 mm, while keeping other variables constant.

FIGS. 4a-c represent 2D and 3D graphical pressure simulation results wherein the diameter of the orifice, D_{orifice} is altered over the selected length and diameter of the pipe, Dₚᵢₚₑ is 3-9 mm and Lₚᵢₚₑ is 300-900 mm, while keeping other variables constant.

FIGS. 5a-c show plots of pressure simulation results wherein the pressure in the chimney is change from −25Pa to -50Pa, and the length and diameter of the pipe is altered, while keeping other variables constant.

FIGS. 6a-c show plots of pressure simulation results with the decreased chimney pressure, −50Pa, and with the diameter of the orifice, D_{orifice}, altered over the selected length and diameter of the pipe, Dₚᵢₚₑ is 3-9 mm and Lₚᵢₚₑ is 300-900 mm, while keeping other variables constant.

FIGS. 7a-c show plots of pressure simulation results for a chimney pressure of −250 Pa over the selected length and diameter of the pipe, Dₚᵢₚₑ is 3-9 mm and Lₚᵢₚₑ is 300-900 mm, while keeping other variables constant.

FIGS. 8a-c show plots of pressure simulation results with the decreased chimney pressure, −250 Pa, and with the diameter of the orifice, D_{orifice}, altered over the selected length and diameter of the pipe, Dₚᵢₚₑ is 3-9 mm and Lₚᵢₚₑ is 300-900 mm, while keeping other variables constant.

FIGS. 9a-d represent 2D and 3D graphical pressure simulation results for a range of chimney pressures, from −25 Pa to −2500 Pa, with FIGS. 9a-c highlighting the 95% of chimney pressure value.

FIG. 10 shows a graph of optimum values of the pipe length and diameter for a chimney pressure of −25 Pa and an orifice diameter of 0.4 mm.

FIGS. 11a-i shows the error in pressure reading for 3 selected pipe and orifice values over the range of chimney pressure of −25 Pa to −2500 Pa. FIGS. 11c, f and i are logarithmic graphs of the graphs in FIGS. 11b, e and h.

FIGS. 12a and b are diagrams of the pressure variations within the pressure sensing device for optimum pipe and orifice parameters. Both the inline (FIG. 12a) and L-shaped (FIG. 12b) configurations are shown.

FIGS. 13a and b are diagrams of the velocity variations within the pressure sensing device for optimum pipe and orifice parameters. Both the inline (FIG. 13a) and L-shaped (FIG. 13b) configurations are shown.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

In an aspect, the present invention is directed to a pressure sensing device, the pressure sensing device comprising:
a first elongated hollow member comprising
a first opening located at a first end of the first elongated hollow member,
a second opening located at a second end opposite to the first end of the elongated hollow member;
a third opening located at between the first and the second end of the first elongated hollow member, and
a second elongated hollow member, the second elongate hollow member being connected to the first elongated hollow member via the third opening, wherein
the first opening being configured to connect the inside of the second elongated member to the inside of a third hollow member;
one of the free end of the second elongated member or third opening configured to open out to external atmospheric pressure through an aperture; and
a pressure sensing element being connected to the other one of the free end of the second elongated member or the third opening.

In an embodiment of the pressure sensing device according to the present invention, the size of the aperture may be between 0.4 mm and 1.2 mm, preferably 0.4 mm, 0.5 mm, 0.6 mm, 0.7 mm, 0.8 mm, 0.9 mm, 1.0 mm, 1.1 mm or 1.2 mm. Accordingly the aperture may form an orifice plate.

In an embodiment of the pressure sensing device according to the present invention, the pressure to be measured inside the third hollow member may be under pressure, below 0 Pa, preferably not exceeding −47200 Pa, more preferably in the range of −25 Pa to −2500 Pa.

In an embodiment of the pressure sensing device according to the present invention, the first elongated hollow member may comprises a first portion with a first length and a first inner diameter and a second portion with a second length and a second inner diameter. In addition thereto, the first portion may be located at the first end of the first elongated hollow member. As such, the first portion may comprise the first opening and may therefore be connected to the inside of the flue. Further, the inner diameter of the first portion may be different from the inner diameter of the second portion, preferably the first inner diameter of the first portion may be bigger than the second inner diameter. The first inner diameter of the first portion may be dependent from the first length of the first portion and may also be dependent from the size of the aperture.

In an embodiment of the pressure sensing device according to the present invention, the inner diameter of the first portion may have any size between 3 mm and 9 mm, preferably between 4 mm and 6 mm, more preferably 5 mm. In addition thereto, the length of the first portion may be up to 5000 mm, preferably between 300 mm and 900 mm, more preferably 600 mm.

In an embodiment of the pressure sensing device according to the present invention, the inner diameter of the second portion may be approximately 3 mm. In addition thereto, the length of the second portion may not be more than 50 mm.

In an embodiment of the pressure sensing device according to the present invention, the pressure sensing element may be connected to the free end of the second elongated member and the third opening is configured to open out to external atmospheric pressure with the aperture.

In an embodiment of the pressure sensing device according to the present invention, the third hollow member may be a flue.

In an aspect, the present invention is further directed to a method for measuring pressure in a flue, the method comprising positioning a pressure sensing element outside a flue using a pressure sensing device as described above.

In an aspect the present invention is further directed to a computer-readable medium having computer-executable instructions adapted to cause a 3D printer to print a pressure sensing device as describe above.

In the following the invention will be described in more detail with reference to the drawings.

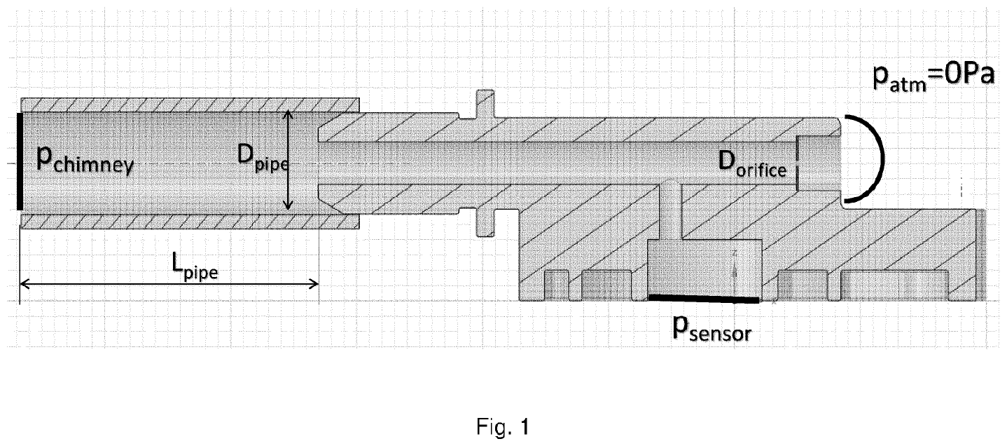

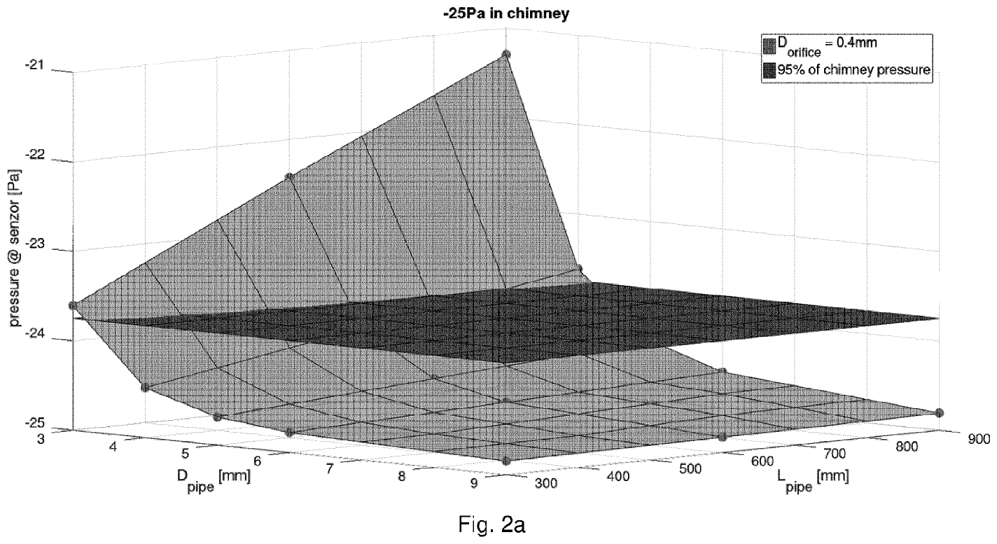

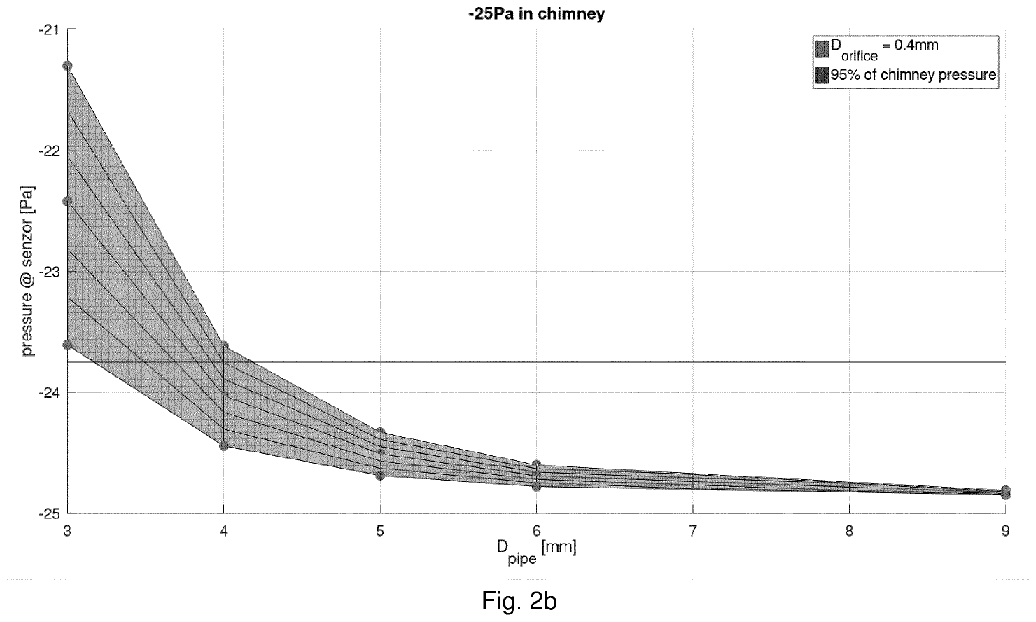

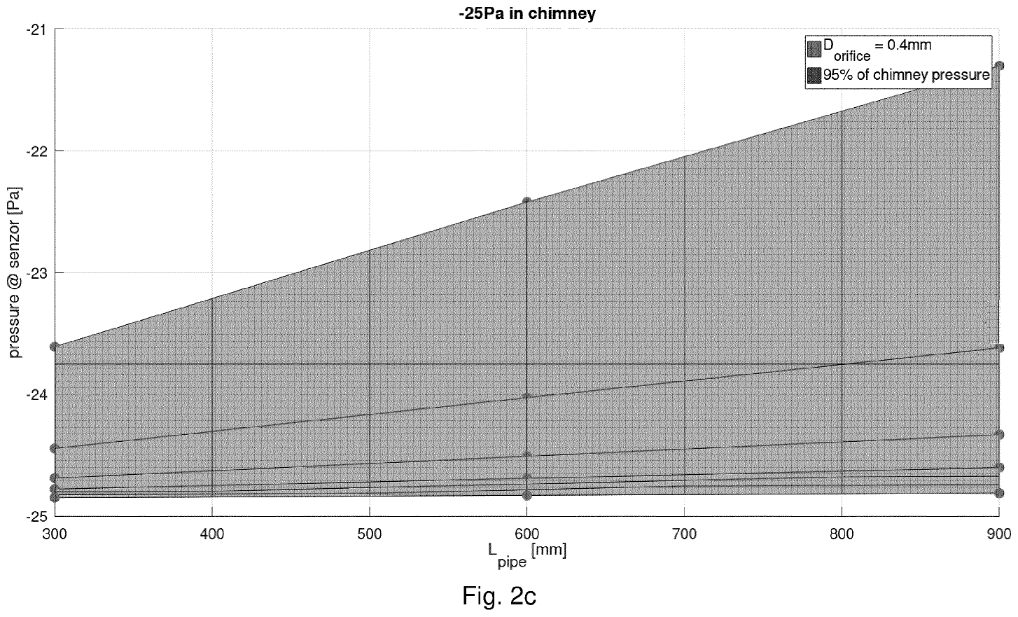

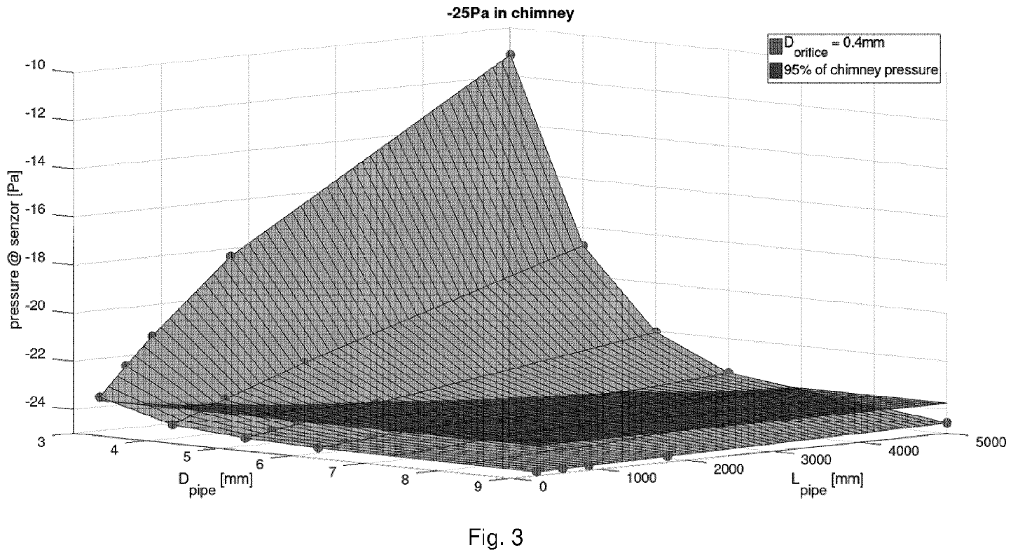

FIG. 1 provides a diagram of a pressure sensing device as described throughout this document as a preferred embodiment. FIG. 1 illustrates that the device can be connected to a flue-like system, for example chimney, pipe, exhaust, etc, for measuring the pressure within such a flue. A first opening of the device allows a connection into a flue and is illustrated by the opening at the end of an elongated hollow member on the left of the diagram, P_{chimney}. On the opposite side of the first opening, P_{chimney}, there is a second opening which is open to the external atmosphere and is indicated by Pₐₜₘ in the diagram. This second opening allows for air to be injected into the device providing an atmospheric flow of air fluid into the elongated hollow member part of the device. As such, the injection of air entering the device through the aperture compensates for diffusion of aggressive chemicals and/or particles from inside the flue into the pressure sensing device. The second opening is representative of an orifice or aperture or the like and as such forming an orifice plate being part of the pressure sensing device. The first elongated hollow member comprises a first and a second portion, wherein the length and inner diameter of the first portion is varied and the length and inner diameter of the second portion is held constant. As illustrated in FIG. 1, the first portion of the elongated member may have a larger inner diameter than the second portion of the elongated member and the length of the first portion may be shorter or longer or substantially the same as the second portion of the elongated hollow member. It is preferable that the length of the second portion should be no more than 50 mm, with an internal diameter of 3 mm. If the second portion is longer than 50 mm with an inner diameter of 3 mm it will affect the accuracy of the pressure measurement. However, if the inner diameter of the second portion is increased the length may also be increased without affecting the accuracy of the pressure measurement. The important relationship between the length and inner diameter of the elongated hollow member is discussed further for the first portion, in relation to FIGS. 2 and 3. A second elongated hollow member is connected to the first elongated hollow member between the first and second openings, i.e. between P_{chimney}and Pₐₜₘ, via a third opening in the first elongated hollow member as shown in FIG. 1. The free end of the second elongated hollow member which is not connected to the first elongated hollow member is connected to a pressure sensing element. The pressure sensing element is indicated by Pₛₑₙₛₒᵣ, in the diagram of FIG. 1. This is referred to as the inline configuration of the pressure sensing device. The pressure sensing element may be a pressure transducer, pressure transmitter, pressure sender, pressure indicator, or the like. In another configuration of the device the pressure sensing element and the second opening, i.e. the orifice, are switched, resulting in an L-shaped configuration. For example, the sensing element is positioned opposite the first opening of the first elongated hollow member at the second opening of the first elongated hollow member and the opening to the atmosphere represented by an orifice is at the free end of the second elongated hollow member. It will be realised by the skilled person that the same technical effect of protecting the sensing element from the polluted environment will be achieved for both configurations of the pressure sensing device. In a preferred embodiment the distance in the second portion of the elongated hollow member between the second elongated member and the orifice (or sensor depending on configuration) is at least 10 mm.

In order to determine the optimum parameters of the device, such that the pressure sensing element is protected while still providing an accuracy reading of the pressure within the flue the accuracy preferably being >95%, the diameter and length of the first portion of the first elongated hollow member, and the diameter of the aperture opening to the external atmosphere at Pₐₜₘ, are varied. The parameters relating to the second portion of the elongated hollow member are held constant throughout the varied simulations, with the length fixed at 50 mm, the diameter fixed at 3 mm and the distance between the orifice and sensor fixed at 10 mm. The effect of the selected device parameters on the pressure measurement of the flue as measured by the pressure sensing element is also determined for the preferred embodiment by varying the pressure within the flue. As such the parameters of respective devices may be adapted to and optimized for specific applications, i.e. the measurement of specific pressure ranges in a flue. These results will be discussed in the following paragraphs in relation to FIGS. 2-11. For ease of reference in discussing the upcoming figures, the first portion of the first elongated hollow member will be referred to as a pipe, the opening to the atmosphere will be referred to as an orifice, the pressure sensing element will be referred to as a sensor, and the flue will be referred to as chimney.

FIGS. 2a-c represent the variation in pressure measured by the sensor when the pipe length and diameter are varied, while keeping the other parameters constant. The chimney pressure, P_{chimney}, is held constant at −25 Pa and the diameter of the orifice, D_{orifice}, is held constant at 0.4 mm. The diameter of the pipe, Dₚᵢₚₑ, is varied between 3-9 mm and the length of the pipe, Lₚᵢₚₑ, is varied between 300-900 mm, as shown in FIGS. 2a-c. The 3D plot in FIG. 2a shows the variation in pressure measured by the sensor for the aforementioned conditions. The 95% accuracy of the pressure measured is highlighted by the 2D profile at −23.75 Pa in FIG. 2a. Similarly, FIGS. 2a and 2b show the variation in pressure for change in pipe diameter and change in pipe length, respectively. Again the 95% accuracy reading is highlighted by the constant line at −23.75 Pa in both plots. It is clear that decreasing the diameter of the pipe and increasing the length results in a higher deviation of pressure measured at the sensor from the pressure set at the chimney, P_{chimney}. However, the length of pipe has a low effect on the pressure reading at the sensor for a pipe with a diameter of higher than approximately 6 mm, within the 3-9 mm range simulated.

In order to establish if the accuracy is maintained for lengths of pipe higher than 900 mm, the pipe length parameter is varied up to 5000 mm while maintaining the same values for the other parameters as illustrated in the 3D plot in FIG. 3. It is clear in FIG. 3 that the pipe length has no effect on the pressure measurement of the sensor for pipe diameter, Dₚᵢₚₑ, of approximately 6-9 mm. Thus, a pressure sensing device with an orifice diameter, D_{orifice}, of 0.4 mm and a pipe diameter, Dₚᵢₚₑ, of approximately 6-9 mm can comprise any length of pipe, up to 5000 mm, while providing an accurate pressure measurement reading and protecting the sensor from the polluted environment within the chimney.

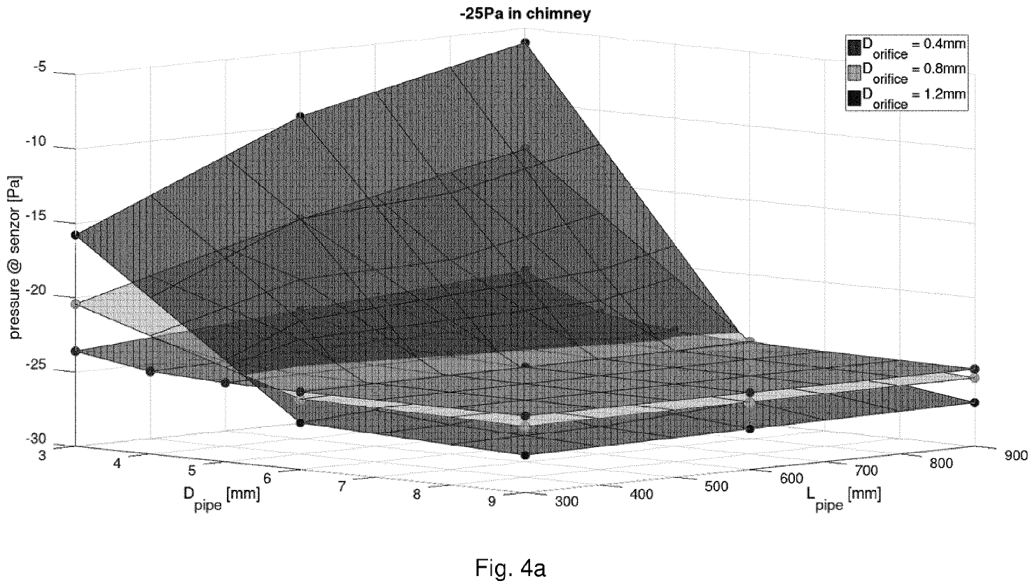

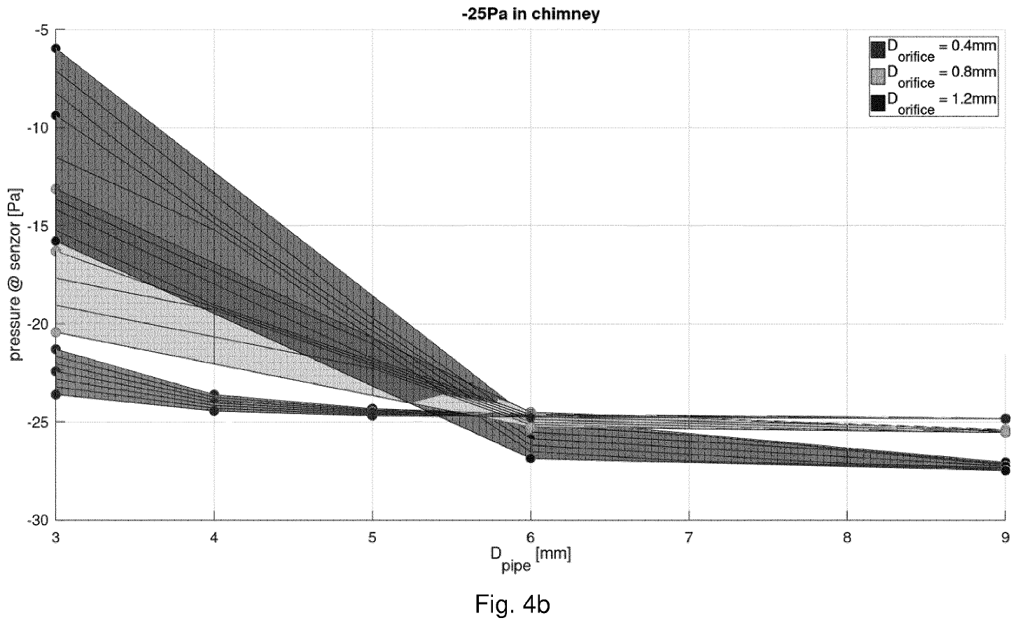

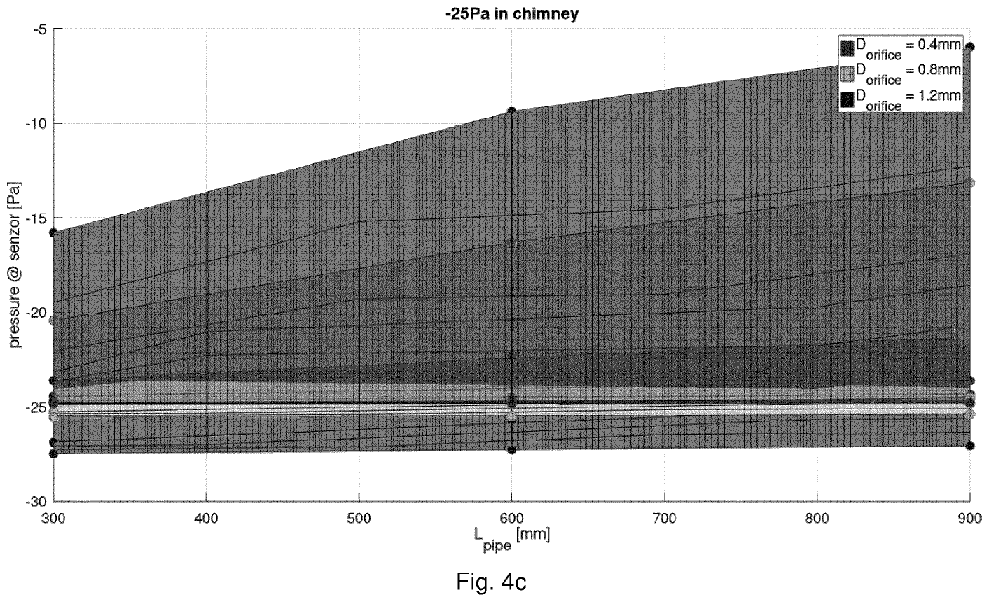

FIGS. 4a-c illustrate the effects on the pressure measured at the sensor for variations in the orifice diameter, D_{orifice}. FIG. 4a shows a 3D plot of the variation in the pressure for 3 different orifice diameter values over a selected range of pipe parameters. Namely, the sensor pressure is measured for an orifice diameter, D_{orifice}, of 0.4 mm, 0.8 mm and 1.2 mm, over a pipe diameter, Dₚᵢₚₑ, range 3-9 mm and a pipe length, Lₚᵢₚₑ, 300-900 mm. The pressure in the chimney, P_{chimney}, is held constant at −25 Pa. The results show that an increase in orifice diameter, D_{orifice}, reduces the accuracy in the pressure reading at the sensor. FIG. 4a clearly illustrates that the pressure measurement for 1.2 mm orifice diameter measures below and above the −25 Pa pressure value of the chimney for all pipe diameters simulated. The same is seen in FIG. 4c for all pipe lengths in the simulated range. Therefore, an orifice diameter, D_{orifice}, between 0.4 mm and 0.8 mm provides for acceptable pressure readings for a pipe diameter higher than approximately 7 mm and for all pipe lengths.

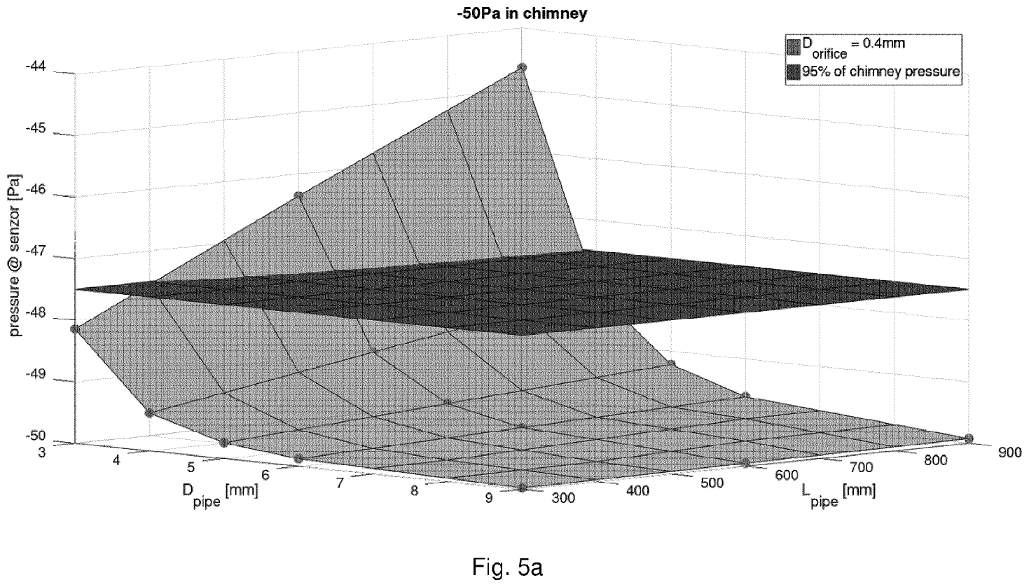

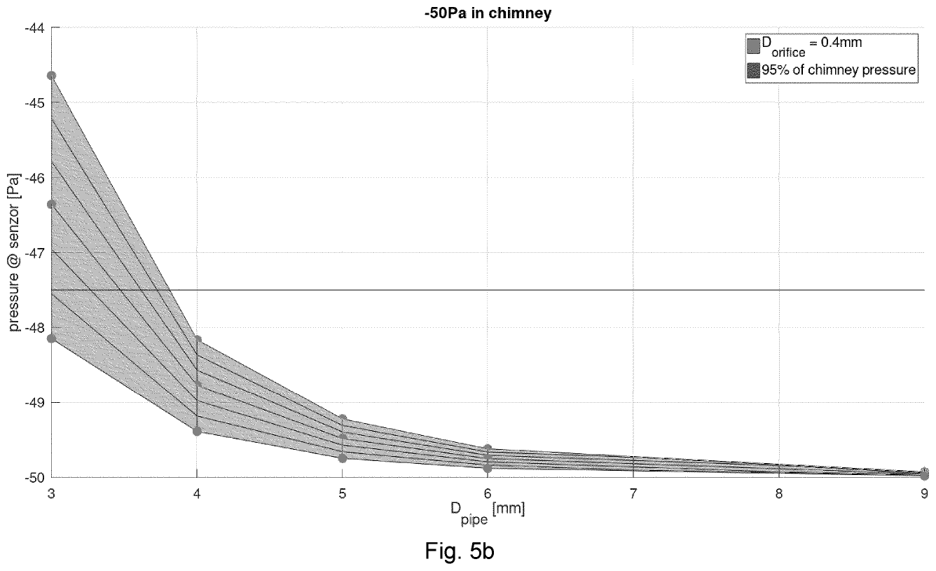

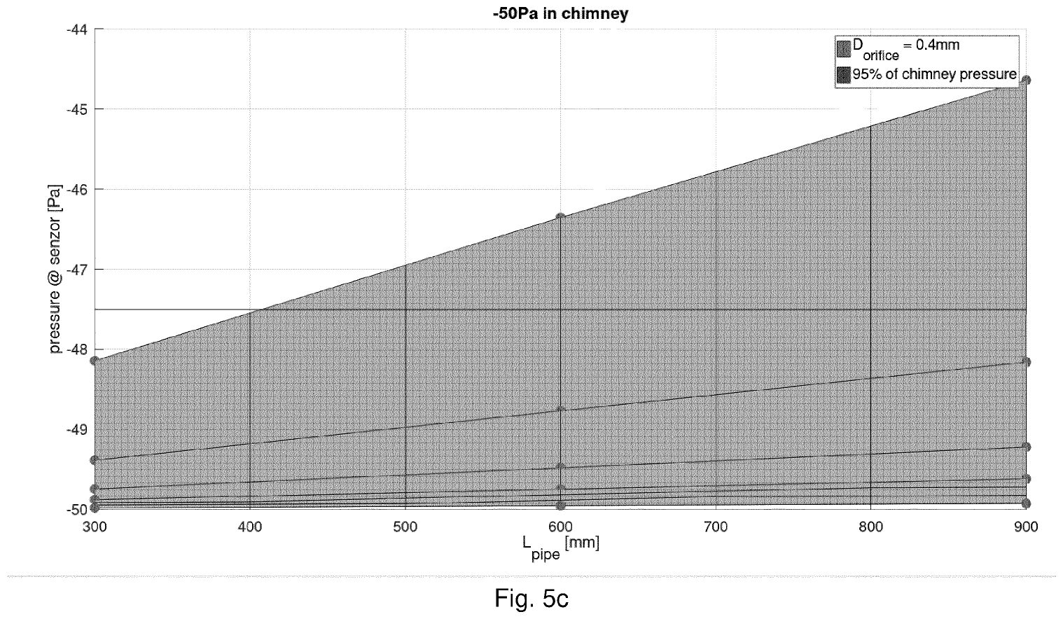

FIGS. 5a-c illustrates the effect on the accuracy of the pressure reading at the sensor when the pressure in the chimney, P_{chimney}, is reduced to −50 Pa. Like in the simulated results of FIGS. 2a-c the orifice diameter, D_{orifice}, is held constant at 0.4 mm and the pipe diameter, Dₚᵢₚₑ, and length, Lₚᵢₚₑ, are varied between 3-9 mm and 300-900 mm, respectively. FIG. 5a highlights the 95% accuracy by the 2D profile within the 3D plot. The 95% accuracy being −47.5 Pa in this case. Similarly, the 95% accuracy is shown in FIGS. 5b and 5c as a line at −47.5 Pa. Further, the sensor measurements exhibit a similar relationship for this −50 Pa pressure to those with −25 Pa pressure in the chimney. Namely, that the decreasing pipe diameter and increasing pipe length results in a higher deviation of pressure from the selected chimney pressure. Again, the length of the pipe has low effect on pressure readings for pipe diameters approximately greater than 6 mm, i.e. ˜ 6-9 mm. Comparing with the −25 Pa chimney pressure, the −50 Pa chimney pressure has a lower error in pressure reading at the sensor, i.e. smaller deviation in pressure, for the same simulated range of parameters.

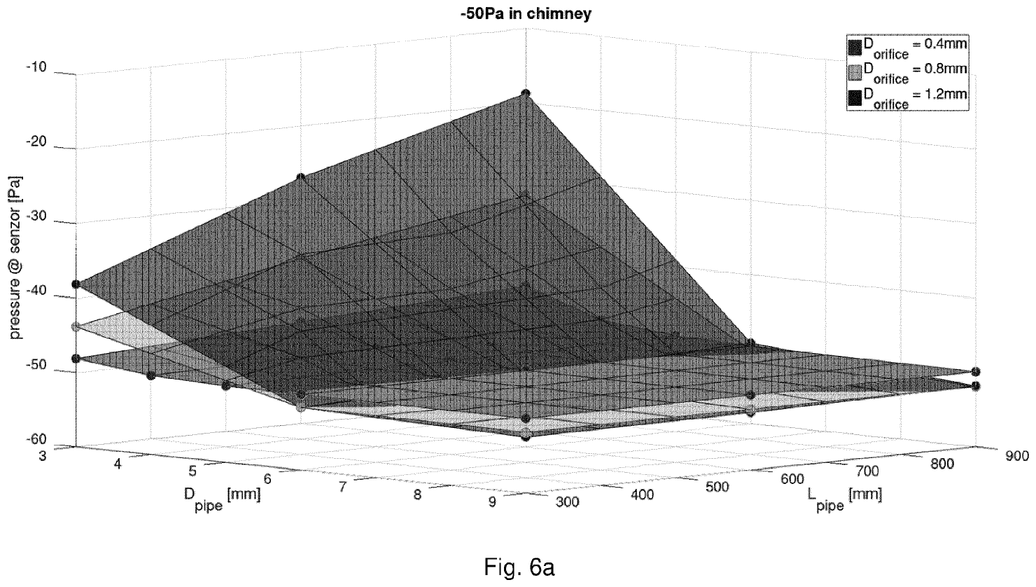

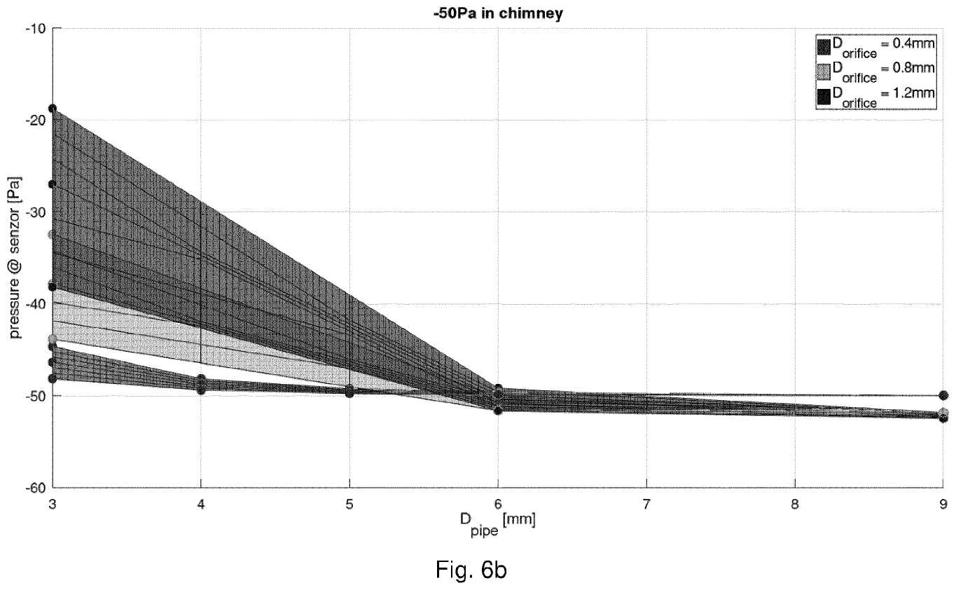

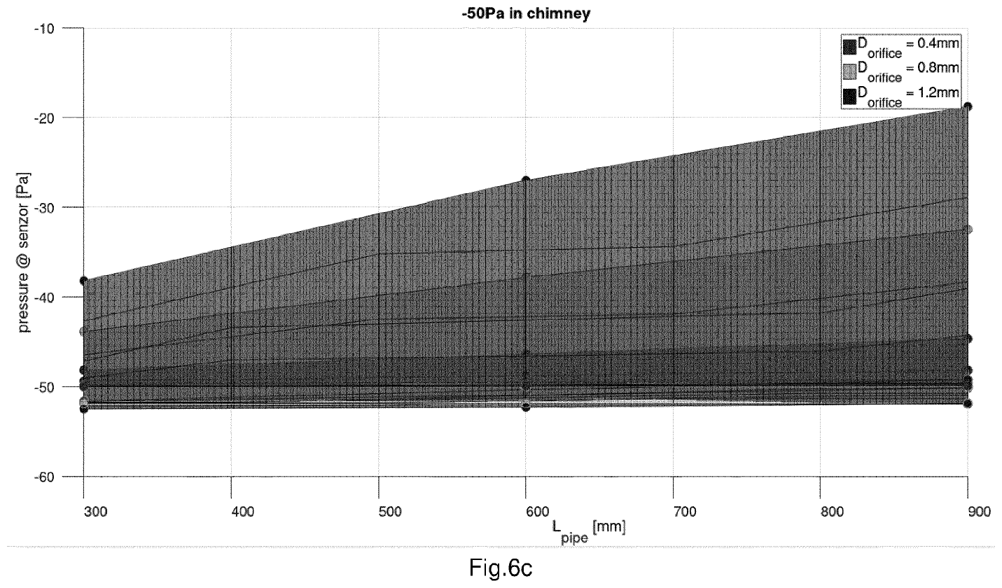

The impact of the orifice diameter on the improved pressure readings for the −50 Pa chimney pressure, when compared to the −25 Pa chimney pressure, is assessed with the same pipe parameters, as shown in FIGS. 6a-c. The same selection of orifice diameters are used, i.e. 0.4 mm, 0.8 mm and 1.2 mm, as were simulated in FIGS. 4a-c. Again, increasing the diameter of the orifice leads to reduced accuracy in the pressure measured at the sensor. However, the deviation from the acceptable value is lower than in the −25 Pa case, i.e. smaller deviations in pressure measurements to the selected chimney pressure, P_{chimney}, especially for the 1.2 mm orifice diameter, D_{orifice},. As such, an orifice diameter, D_{orifice}, between 0.4 mm and 0.8 mm provides for acceptable pressure readings for a pipe diameter, Dₚᵢₚₑ, higher than approximately 6 mm and for all pipe lengths, Lₚᵢₚₑ.

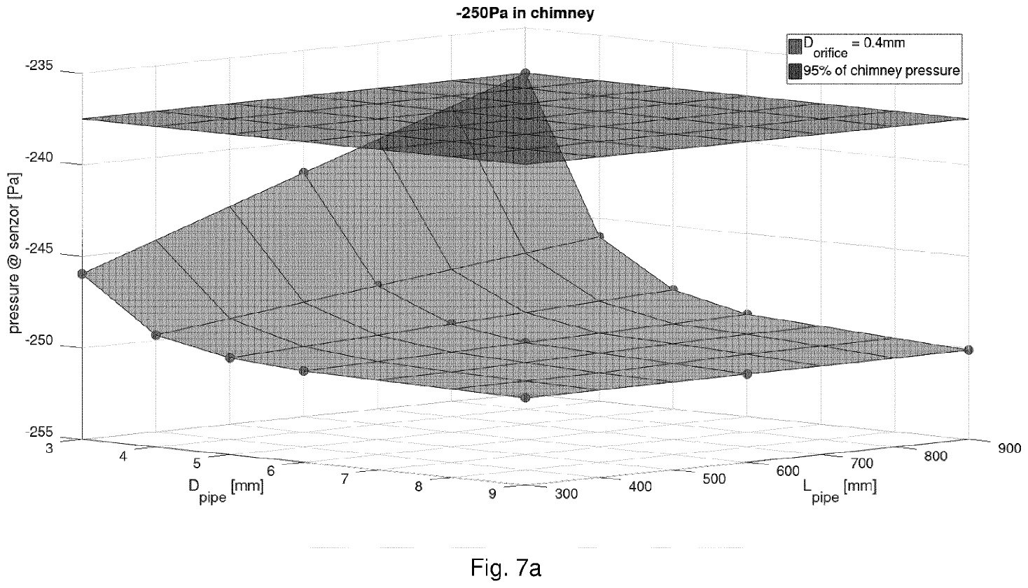

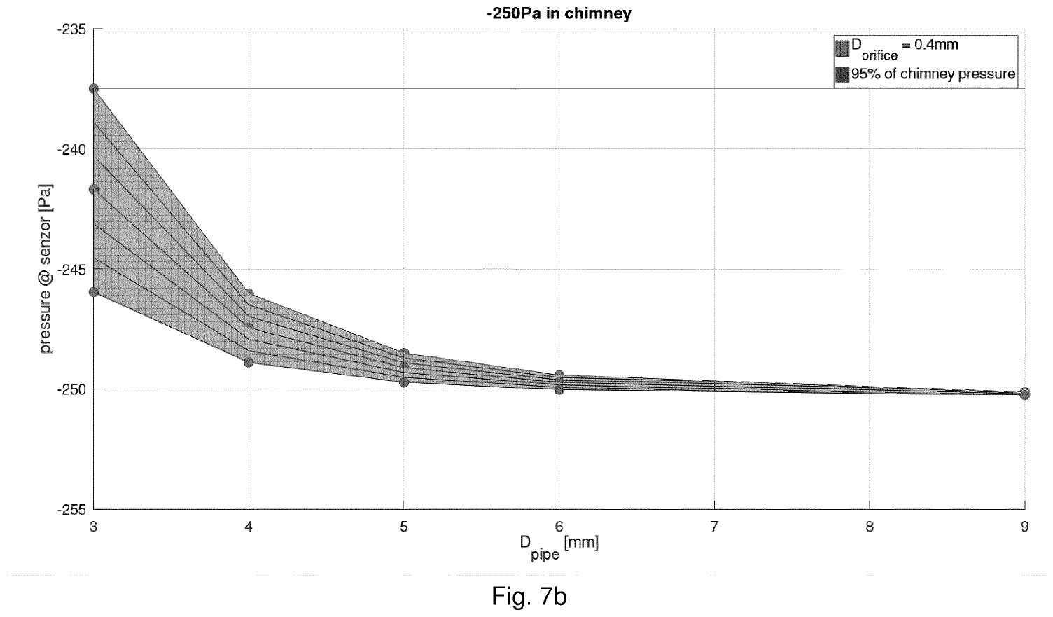

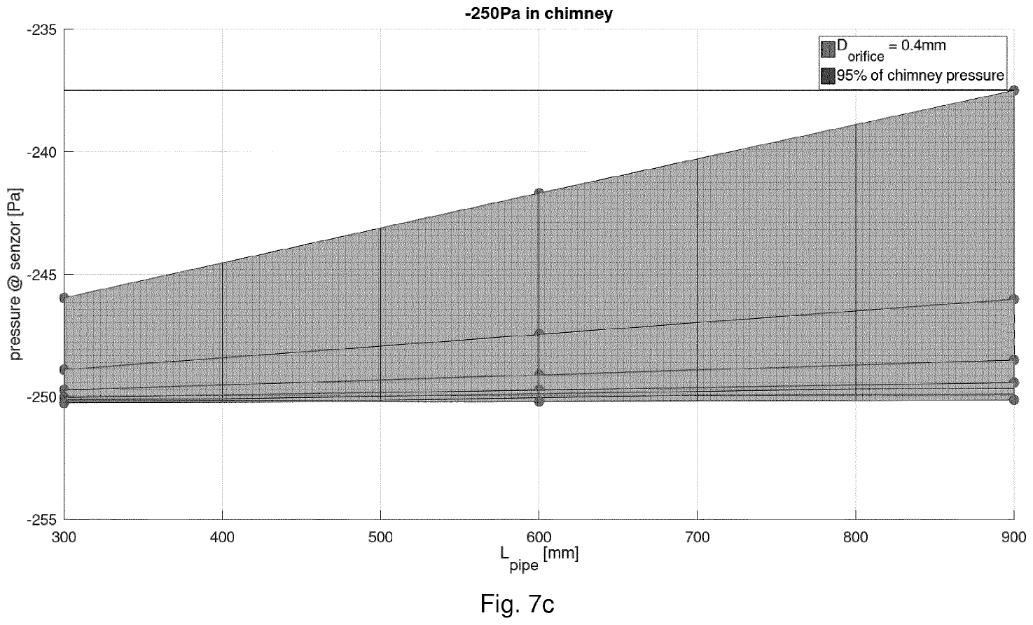

FIGS. 7a-c represent similar conditions as to those represented in FIGS. 2a-c and FIGS. 5a-c but the chimney pressure, P_{chimney}, is further reduced to −250 Pa. Again, a decrease in pipe diameter and an increased in pipe length results in a higher deviation of pressure measured at the sensor, as shown in FIG. 7a. Further, the length of pipe has a low effect on the pressure reading for a pipe diameter, Dₚᵢₚₑ, of approximately 6-9 mm. The 95% accuracy of the measured pressure at the sensor is again marked by the 2D profile in the plot of FIG. 7a and a line in the plots of FIGS. 7b and 7c. The 95% accuracy pressure value being −237.5 Pa. Even although there is an increase in deviation from the measured value of −250 Pa for pipe parameter values of lower diameter and higher length, all measured pressures are within the 95% accuracy for all simulated pipe parameters. Thus, there is an improved accuracy when decreasing the pressure value of the chimney, from −25 Pa to −50 Pa to −250 Pa, when simulated under the same conditions, i.e. the same range of pipe parameters and constant orifice value.

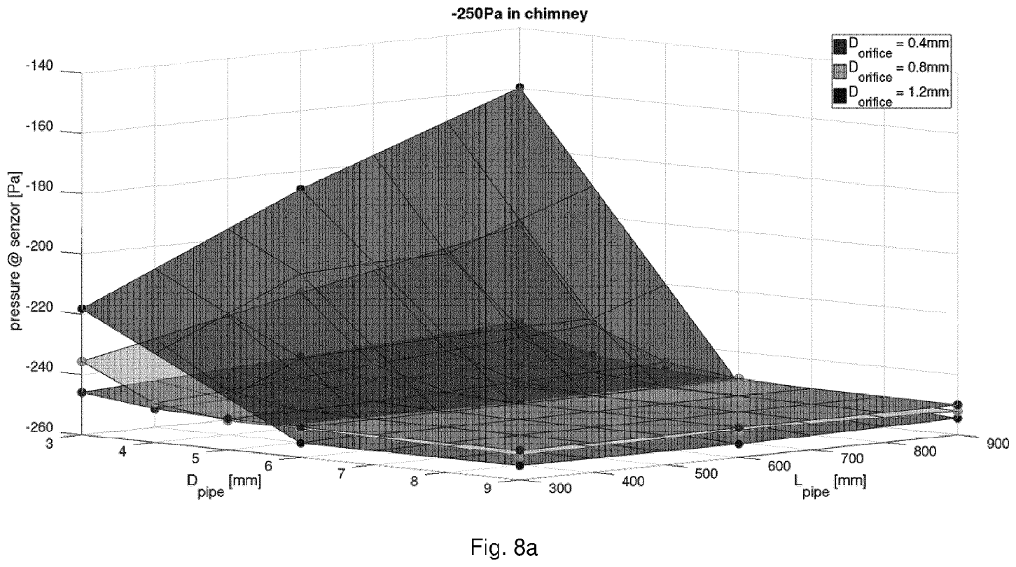

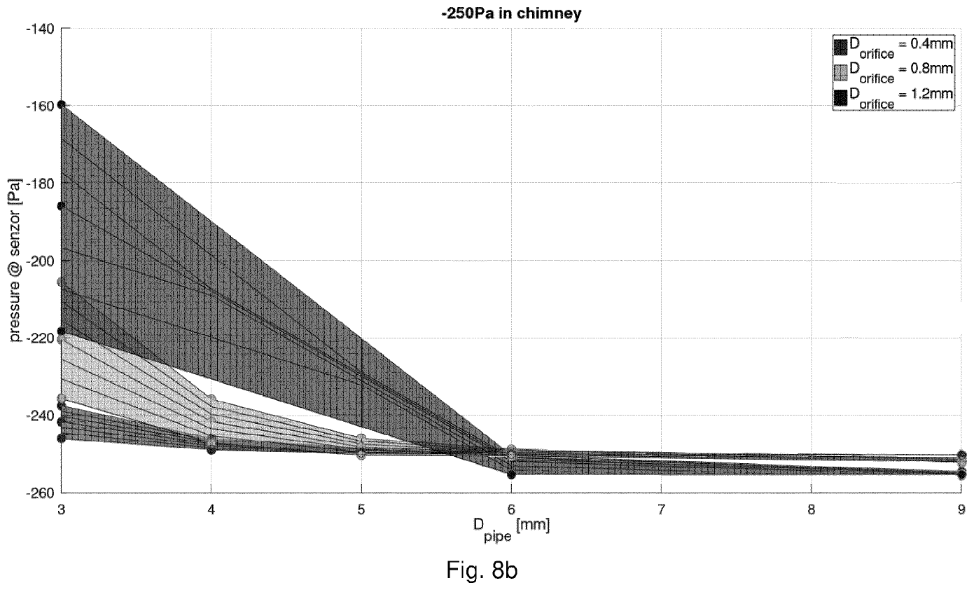

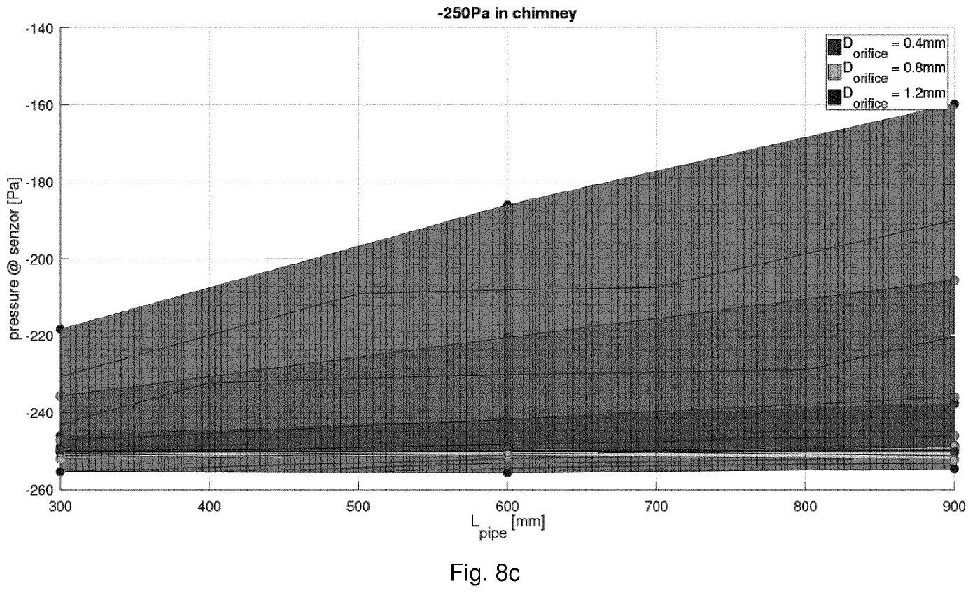

The influence of the various orifice diameters on the accuracy of the pressure measurements at −250 Pa is shown in FIGS. 8a-c. The same selection of orifice diameters are used, i.e. 0.4 mm, 0.8 mm and 1.2 mm, as were simulated in FIGS. 4a-c and FIGS. 6a-c.

Again, increasing the diameter of the orifice, D_{orifice}, leads to reduced accuracy in the pressure measured at the sensor. Further, the change in deviation of the measured pressure value over the selected parameters is again lower, when compared to the −50 Pa chimney pressure value and the −25 Pa value of the previous simulations. As such, there are even smaller deviations in the pressure measurements from the selected chimney pressure of −250 Pa, especially for the 1.2 mm orifice diameter, D_{orifice}. Therefore, an orifice diameter, D_{orifice}, between 0.4 mm and 0.8 mm provides for acceptable pressure readings for a pipe diameter, Dₚᵢₚₑ, higher than approximately 6 mm and for all pipe lengths, Lₚᵢₚₑ.

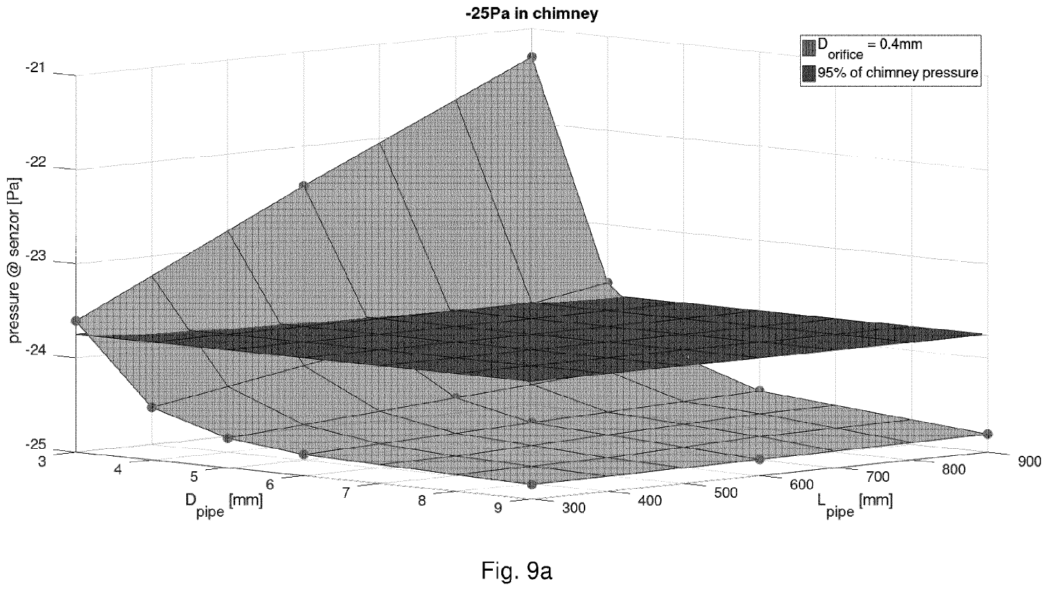

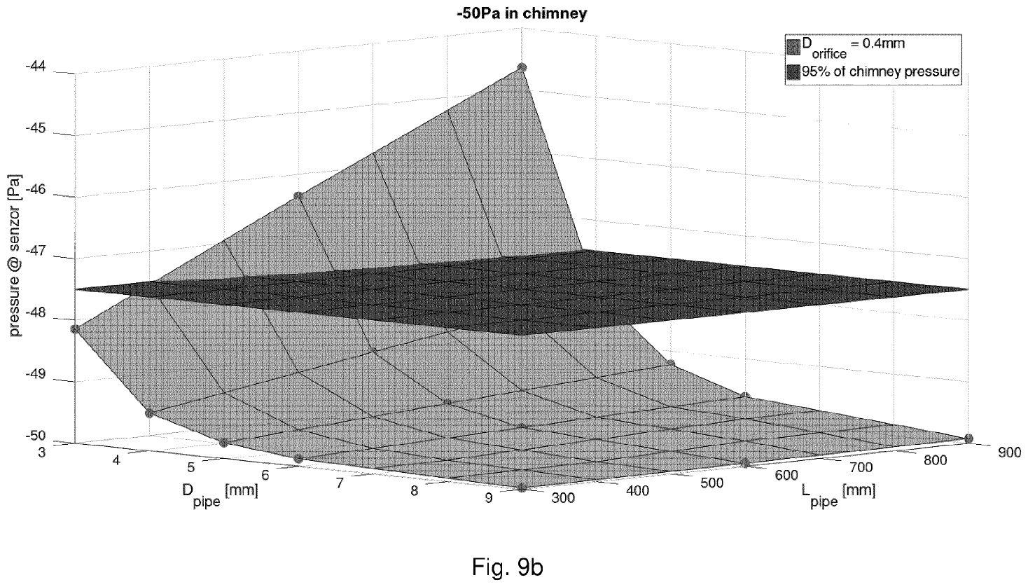

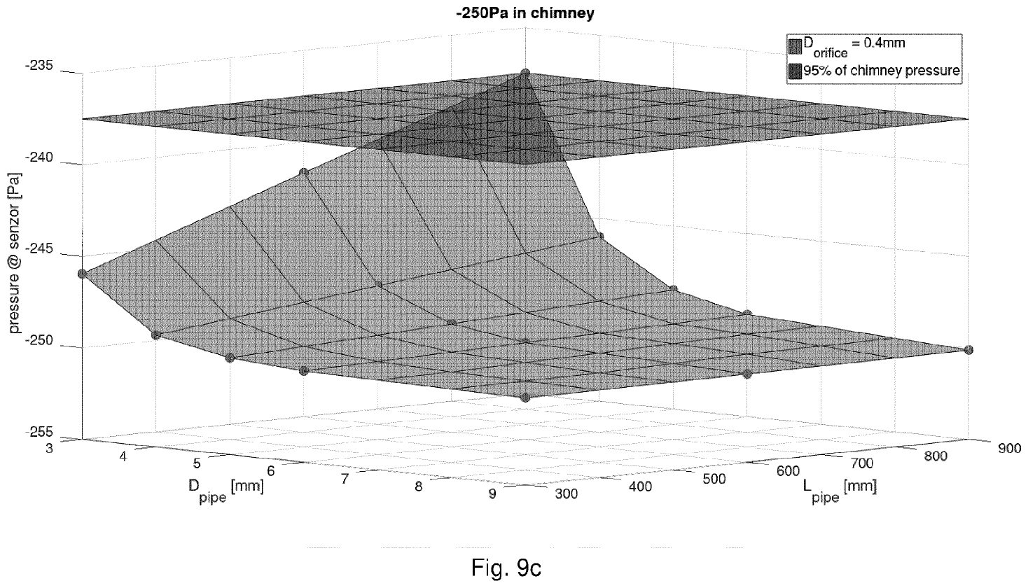

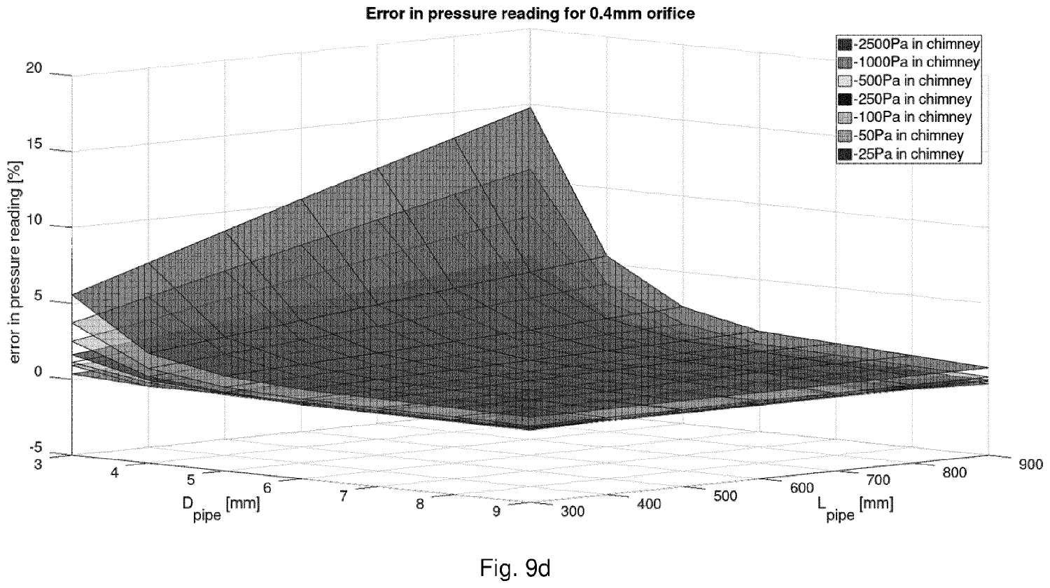

The deviations of the measured pressure value at the sensor from the set pressure are represented by the plots in FIGS. 9a-d. FIGS. 9a-c are shown with the same conditions as represented by FIGS. 2a, 5a and 7a, i.e. orifice diameter of 0.4 mm, pipe diameter 3-9 mm and pipe length 300-900 mm. FIGS. 9a-c highlight the decrease in deviation with an increase in chimney pressure, P_{chimney}, going from FIG. 9a to FIG. 9b to FIG. 9c which represent −25 Pa, −50 Pa and −250 Pa, respectively. For ease of comparison, the error associated with each of the deviations of the selected chimney pressure values as measured at the sensor is calculated. The error is calculated as:

$$error = ( 1 - ( \frac{{P}_{sensor}}{{P}_{chimney}} ) ) \times 100$$

Where Pₛₑₙₛₒᵣ is the measured pressure at the sensor and P_{chimney} is the selected chimney pressure value. FIG. 9d is a 3D plot of the error values in the pressure reading at the sensor for an orifice diameter, D_{orifice}, of 0.4 mm, pipe diameter, Dₚᵢₚₑ, 3-9 mm and pipe length, Lₚᵢₚₑ, 300-900 mm. In addition to the error values associated with the −25 Pa, −50 Pa and −250 Pa chimney pressures, FIG. 9d also shows the error values for the same conditions but with −100 Pa, −500 Pa, −1000 Pa and −2500 Pa chimney pressures. As such the plot shows a decrease in error of pressure reading for a decreased chimney pressure, i.e. a higher pressure difference between the inside of the chimney and the external atmosphere. Thus, this pressure sensing device is well suited for low pressure environments, providing higher accuracy pressure readings while protecting the sensing element of the pressure sensor from the polluted environment of the chimney.

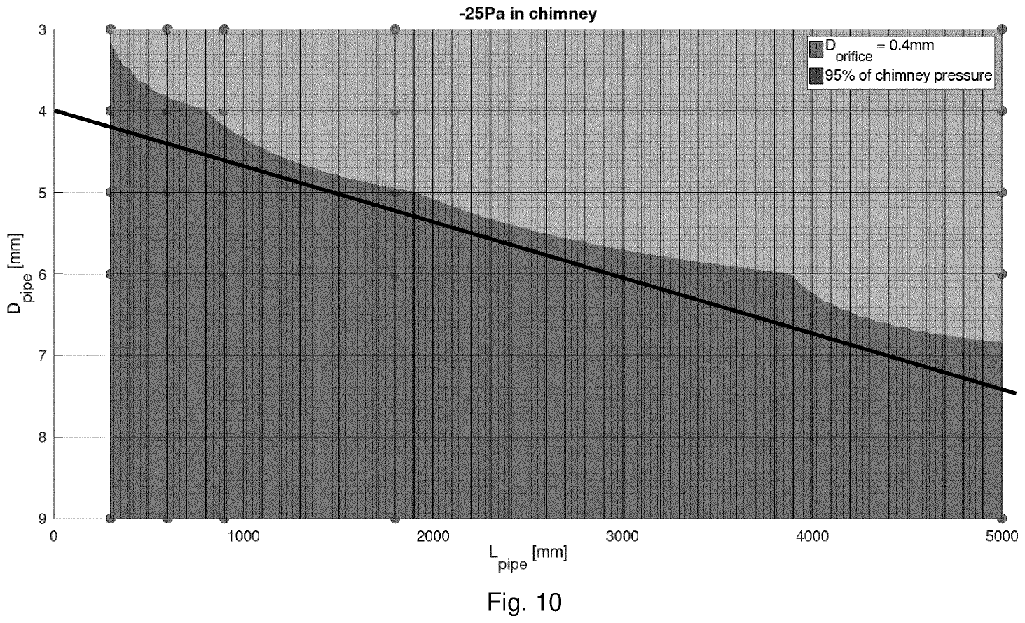

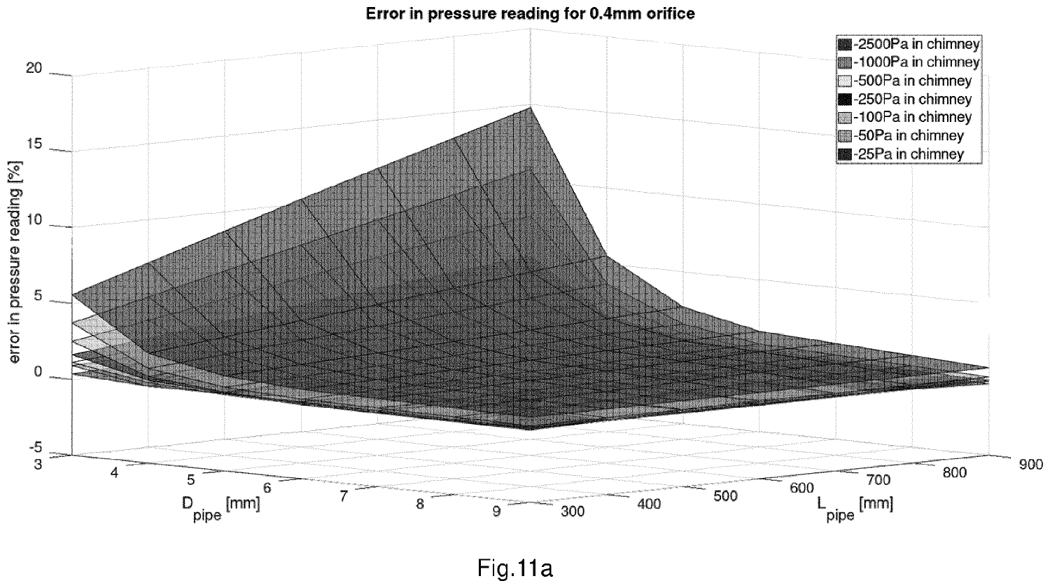

For the preferred pressure sensing applications associated with this invention the pressure is at the higher end of the pressure range simulated, i.e. −25 Pa and -50 Pa. As such, FIG. 10 shows a plot of the optimum pipe parameters for a chimney pressure, P_{chimney}, of −25 Pa and an orifice diameter, D_{orifice}, of 0.4 mm. A relationship between the diameter of the pipe and the length of the pipe is found to be:

Dₚᵢₚₑ<0.0007 5Lₚᵢₚₑ+4

Wherein Dₚᵢₚₑ is the diameter of the pipe and Lₚᵢₚₑ is the length of the pipe and the values are recorded in millimetres. The relationship of pipe diameter to pipe length allows for extensive combinations of pipe configurations while maintaining a high accuracy/low error measurement reading at the sensor. The above equation is presented on the plot in FIG. 10 by the black solid line. It is clear that this is well within the 95% accuracy threshold for measuring the chimney pressure. Thus, any configuration of values under this line has an acceptable tolerance for measuring the pressure of the chimney at the sensor.

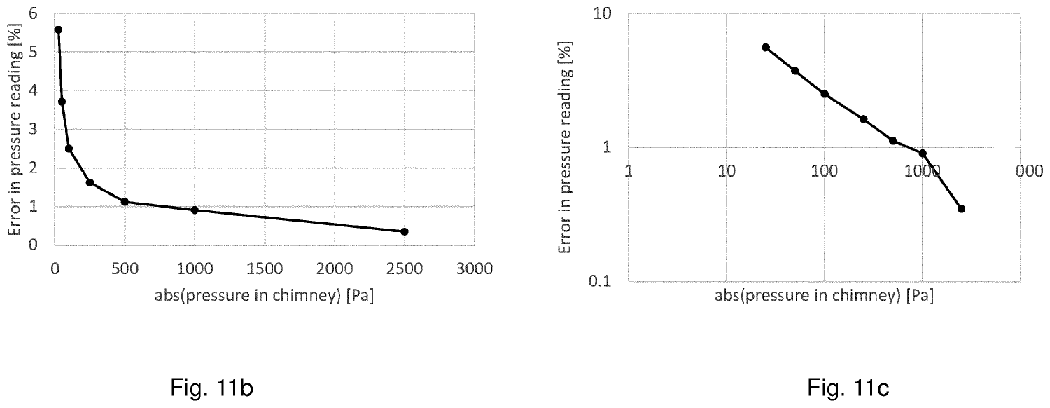

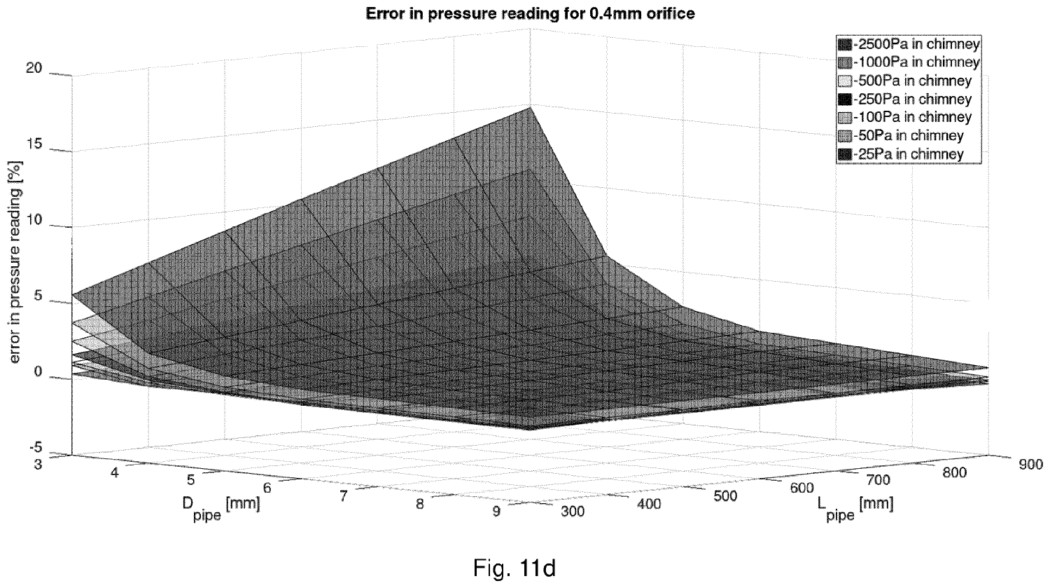

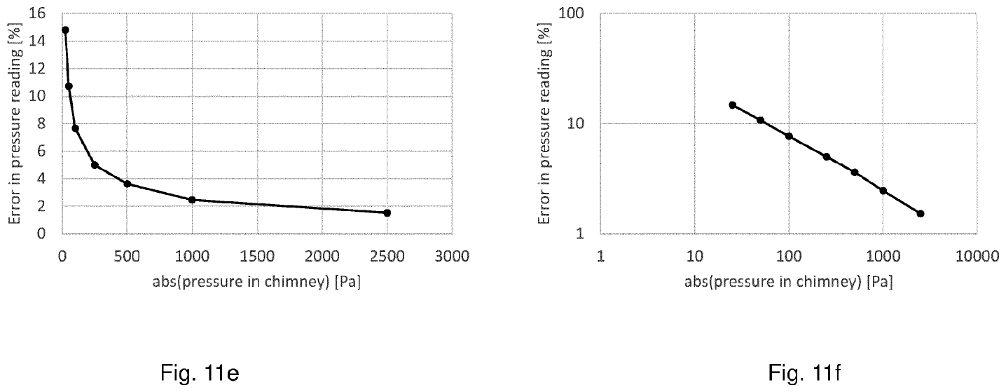

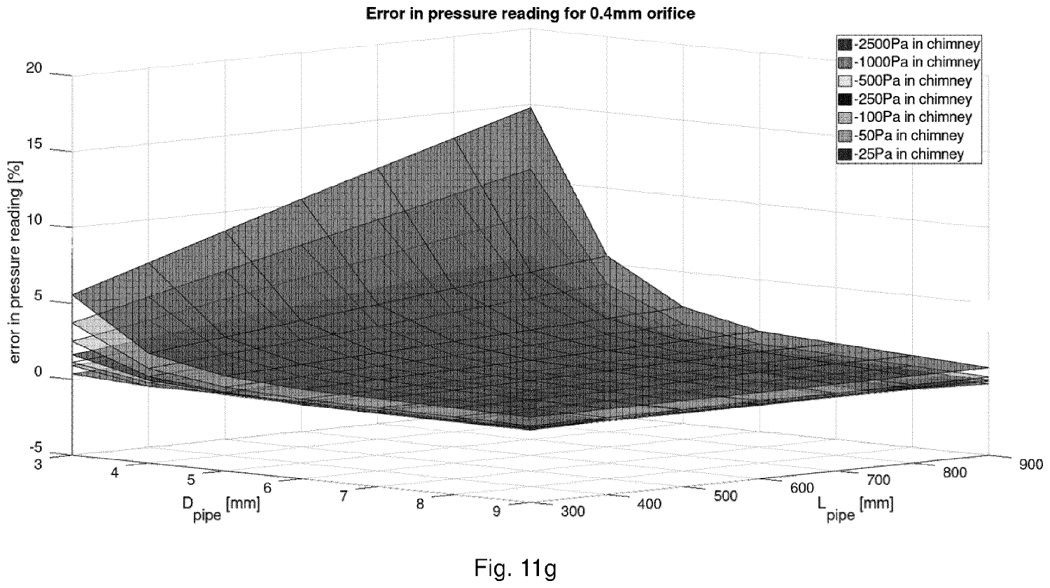

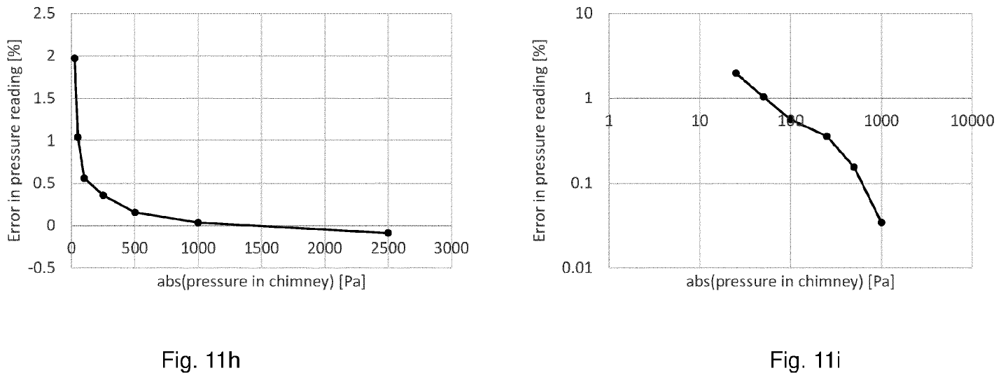

FIGS. 11a-i show the error in reading the pressure at the sensor for selected combinations of pipe length, Lₚᵢₚₑ, and diameter over a range of chimney pressures. The orifice diameter, D_{orifice}, is fixed at 0.4 mm for all simulations. Different conditions have been selected to assess the impact of the change in chimney pressure on the error reading of the pressure measured at the sensor under such conditions. FIGS. 11a-c are results of a pipe configuration approximate the 95% accuracy value at a starting chimney pressure, P_{chimney}, of −25 Pa, as shown in FIG. 10. The pipe parameters are 3 mm for pipe diameter, Dₚᵢₚₑ, and 300 mm for pipe length, Lₚᵢₚₑ. FIGS. 11d-f show the results when the pipe configuration is outside the 95% accuracy value at a starting chimney pressure of −25 Pa. The parameters in this case are 3 mm pipe diameter, Dₚᵢₚₑ, and 900 mm pipe length, Lₚᵢₚₑ. FIG. 10 shows this configuration on the upper right section of the plot, i.e. outside the 95% accuracy threshold. FIGS. 11g-i are the results of a pipe configuration inside the 95% accuracy threshold, where the pipe diameter, Dₚᵢₚₑ, is 5 mm and the pipe length, Lₚᵢₚₑ, is 600 mm. Again this can be easily seen in the plot in FIG. 10 where this pipe configuration lies in the lower left section of the plot, i.e. inside the 95% accuracy threshold. It is clear that all of the selected combinations have a negative exponential drop in the error reading with increasing chimney pressure. This reduction in error value is clear in the logarithmic plots of FIGS. 11c, 11f and 11i. From these results, it can be deduced that even if the pipe configuration is outside the 95% accuracy threshold for a low pressure value, e.g. −25 Pa, it can be used for chimney pressures of decreased value, e.g. −500 Pa.

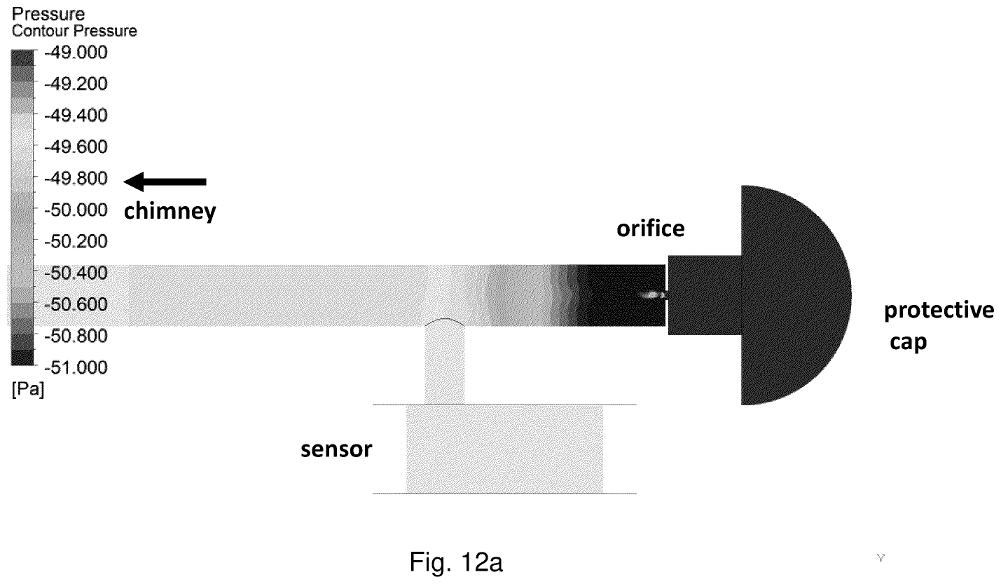

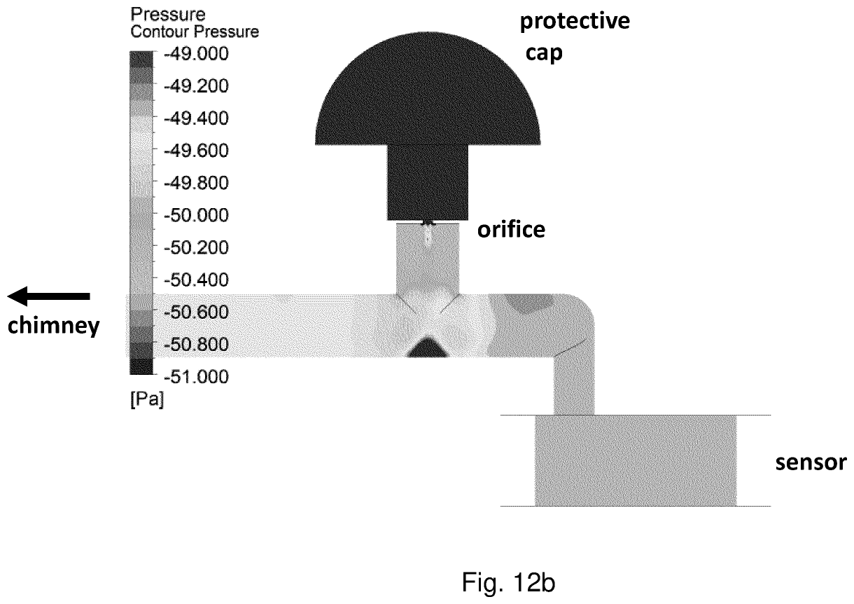

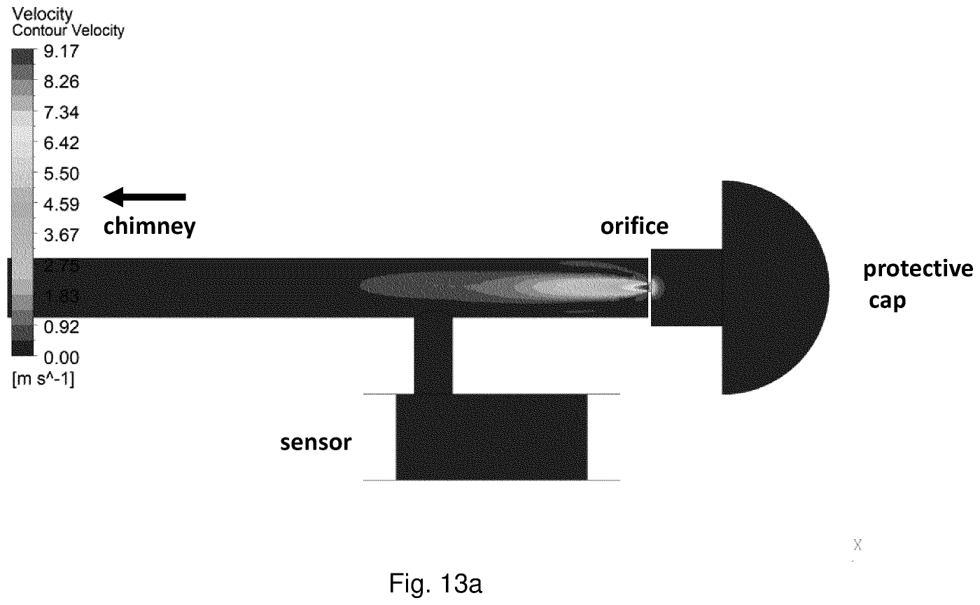

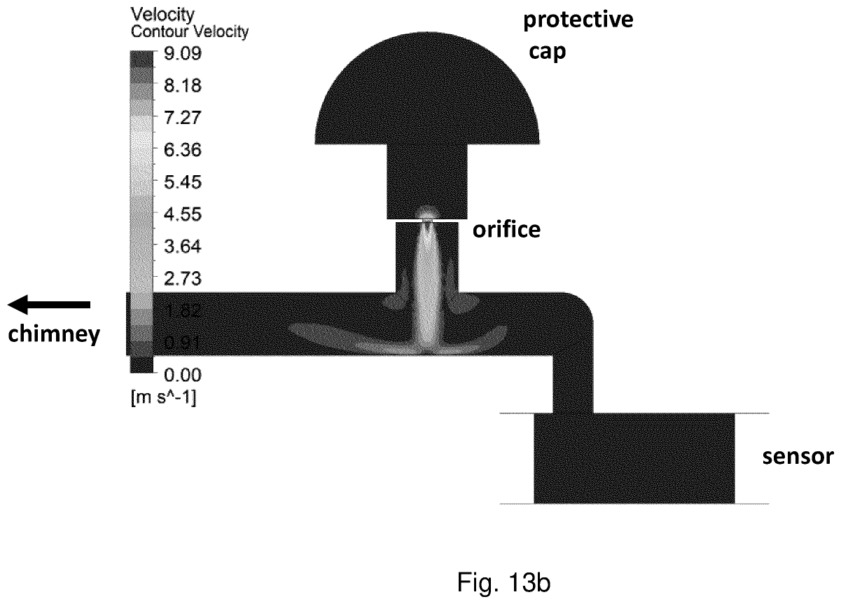

FIGS. 12a and b show the pressure variations within the pressure sensing device for optimum pipe and orifice parameters. The parameters are: Dₚᵢₚₑ =3 mm, Lₚᵢₚₑ=300 mm and D_{orifice}=0.4 mm. FIG. 12a shows the pressure sensing device with the inline configuration and FIG. 12b shows the alternative L-shaped (12b) configuration. The chimney pressure, P_{chimney}, is set at −50 Pa. In both FIGS. 12a and 12b the influence of the external atmospheric pressure injecting into the orifice opening is shown. The air flowing inside the opening of the pipe, i.e. inside the first or second elongated hollow member, protects the contaminants from the chimney reaching the sensor. This shown more clearly in FIGS. 13a and b. The pressure measured by the sensor for the inline configuration, i.e. in FIG. 12a, is −49.57 Pa which is an accuracy of over 99%. The pressure measured by the sensor in the L-shaped configuration is −49.30, which is a slightly higher deviation than the inline configuration. However, the accuracy is still over 98%, making it more than acceptable as a pressure sensing device. As indicated in FIGS. 12a and b, a protective cap may be attached to the orifice end of the pressure sensing device to protect from any debris getting into the device.

FIGS. 13a and b are diagrams of the velocity variations within the pressure sensing device for the same optimum pipe and orifice parameters as chosen in FIGS. 12a and b. Both the inline (FIG. 13a) and L-shaped (FIG. 13b) configurations are shown. These diagrams show the influence of the external air flow being injected into the pipe, highlighting the function of the orifice opening in protecting the sensor. Air flow rushes in through the orifice and pushes the contaminants and pollutants back down the pipe towards the chimney while still allowing the pressure of the chimney to be measured by the sensor. Therefore, the contaminants do not reach the sensor or sensing element and the sensing element is protected from any damages or debris covering the sensor. Thus, the lifetime of the senor and the efficiency of the sensor is prolonged. As in FIGS. 12a and b, a protective cap can be attached to the orifice end of the pressure sensing device to protect any debris getting into the device, as shown in FIGS. 13a and b.

The pressure sensing device as discussed throughout this document may be manufactured in a number of ways as separate components or as a single component. One manufacturing possibility is to 3D print the component parts either individually or as a single unit. The sensing element would be incorporated into the device after the manufacturing of the components if produced via 3D printing.

From the foregoing, it will be observed that numerous variations and modifications may be effected without departing from the scope of the invention. It is to be understood that no limitation with respect to the specific device or method described herein is intended or should be inferred. It is, of course, intended to cover all such modifications as fall within the scope of the invention

1. A pressure sensing device, comprising:
a first elongated hollow member comprising a first opening located at a first end of the first elongated hollow member;
a second opening located at a second end opposite to the first end of the elongated hollow member;
a third opening located at between the first and the second end of the first elongated hollow member, and
a second elongated hollow member, the second elongated hollow member being connected to the first elongated hollow member via the third opening, wherein
the first opening being configured to connect the inside of the second elongated member to the inside of a third hollow member;
one of the free end of the second elongated member or third opening configured to open out to external atmospheric pressure through an aperture; and
a pressure sensing element being connected to the other one of the free end of the second elongated member or the third opening.

2. The pressure sensing device according to claim 1, wherein the size of the aperture is between 0.4 mm and 1.2 mm.

3. The pressure sensing device according to claim 1, wherein the pressure inside the third hollow member is below 0 Pa.

4. The pressure sensing device according to claim 1, wherein the first elongated hollow member comprises a first portion with a first length and a first inner diameter and a second portion with a second length and a second inner diameter.

5. The pressure sensing device according to claim 4, wherein the first portion is located at the first end of the first elongated hollow member.

6. The pressure sensing device according to claim 4, wherein the inner diameter of the first portion is different from the inner diameter of the second portion.

7. The pressure sensing device according to claim 6, wherein the inner diameter of the first portion is between 3 mm and 9 mm.

8. The pressure sensing device according to claim 4, wherein the length of the first portion is up to 5000 mm.

9. The pressure sensing device according to claim 4, wherein the inner diameter of the second portion is approximately 3 mm.

10. The pressure sensing device according to claim 9, wherein the length of the second portion is not more than 50 mm.

11. The pressure sensing device according to claim 1, wherein the pressure sensing element is connected to the free end of the second elongated member and the third opening is configured to open out to external atmospheric pressure with the aperture.

12. The pressure sensing device according to claim 1, wherein the third hollow member is a flue.

13. A method for measuring pressure in a flue, the method comprising:
positioning a pressure sensing element outside a flue using a pressure sensing device according to claim 1.

14. A computer-readable medium having computer-executable instructions adapted to cause a 3D printer to print a device according to claim 1.

15. The pressure sensing device according to claim 2, wherein the pressure inside the third hollow member is below 0 Pa.

16. The pressure sensing device according to claim 15, wherein the pressure inside the third hollow member does not exceed −47200 Pa.

17. The pressure sensing device according to claim 5, wherein the inner diameter of the first portion is different from the inner diameter of the second portion.

18. The pressure sensing device according to claim 4, wherein the first inner diameter is bigger than the second inner diameter.

19. The pressure sensing device according to claim 2, wherein the first elongated hollow member comprises a first portion with a first length and a first inner diameter and a second portion with a second length and a second inner diameter.

20. The pressure sensing device according to claim 3, wherein the first elongated hollow member comprises a first portion with a first length and a first inner diameter and a second portion with a second length and a second inner diameter.
